(19) United States
(12) Patent Application Publication
(10) Pub. No.: US 2025/0222664 A1
(43) Pub. Date: Jul. 10, 2025

(54) METHOD OF CUTTING PLIES AND THE USE THEREOF, A COMPOSITE LAMINATE, A WIND TURBINE BLADE AND A CUTTING APPARATUS

(71) Applicant: ENVISION ENERGY., LTD, Jiangyin, Wuxi, Jiangsu (CN)

(72) Inventors: Sorensen TOMMY, Wuxi, Jiangsu (CN); Longjun SHAN, Wuxi, Jiangsu (CN); Xiangyang ZHANG, Wuxi, Jiangsu (CN); Hao MA, Wuxi, Jiangsu (CN)

(21) Appl. No.: 18/870,560

(22) PCT Filed: May 26, 2022
(86) PCT No.: PCT/CN2022/095207

§ 371 Date: Nov. 29, 2024

Related U.S. Application Data
(63) Continuation of application No. PCT/CN2022/077056, filed on Feb. 21, 2022.

(30) Foreign Application Priority Data
Feb. 21, 2022 (WO) PCT/CN2022/077056

(51) Int. Cl. B29C 70/54; B29L 31/08; F03D 1/06

(52) U.S. Cl. CPC B29C 70/545; F03D 1/0675; B29C 2793/0027; B29C 2793/0081; B29L 2031/085; F05B 2280/6003

(57) ABSTRACT

The disclosure relates to a method of cutting plies of a composite laminate, a composite laminate thereof, a wind turbine blade with such composite laminate, and a cutting apparatus thereof. The cutting apparatus includes cutting elements for performing a plurality of first and second local cuts in the terminated edge area of the ply. The first and second cuts define a plurality of cutaways. The cutting apparatus further includes means for removing the cut-off pieces from the terminated edge area. The shortened fibres and the uncut fibres are optionally mixed along the terminated edge area to form a chamfering of the terminated edge. Alternatively, the fibres are shortened along different first cutting lines wherein a percentage of the fibres at each first cut are shortened to form shortened fibres with different lengths.

### CROSS-REFERENCE OF RELATED APPLICATIONS

The present application is a national phase entry under 35 U.S.C. § 371 of International Application No. PCT/CN2022/095207 filed on May 26, 2022, which claims priority to the PCT Patent Application No. PCT/CN2022/077056 filed on Feb. 21, 2022, the entire contents of which are hereby incorporated by reference.

### FIELD

The present disclosure relates to a method of cutting plies for use in a composite laminate, wherein a terminated end of the ply is modified into a chamfered edge using a cutting apparatus. The modified plies are laid up relative to each other to form a composite laminate, which is afterwards infused with a resin matrix material and cured to form a composite laminate structure.

The present disclosure also relates to a composite laminate, a method of manufacturing a wind turbine blade, and a cutting apparatus.

### BACKGROUND

It is known to use plies with different widths, thicknesses and/or lengths during production of large composite structures, such as wind turbine blades. The plies are arranged in a mould in a predetermined order so to form a laminate of layers having a thickness, width and length. The laminate may have a tapered profile at the side edges, optionally also at the end edges, where the thickness of the laminate is gradually reduced. The plies may be supplied on rolls having a standard width, thickness, and length and then cut into the desired width and/or length before or during the lay-up process using a cutting tool. The lay-up order and the dimensions of the individual plies may be determined by generating a computer model of the laminate, e.g., as disclosed in U.S. Pat. No. 9,524,356 B2.

It is known that ply drops lead to air pockets, resin pools and strain concentrations at the ends and/or sides of the laminate, particularly at the terminated end of a laminate layer between an upper laminate layer and a lower laminate layer. The use of thick plies in the laminate further leads to wrinkles in the upper fibre layers overlapping the terminated edges of fibre layers located below. This adverse ply drop effect increases as the thickness of the plies increases.

The same problem arises if fibre strands are impregnated with resin and pulled through a heated curing station to form a pultruded element. The pultruded elements have a greater thickness than the dry plies and are stacked in the blade mould to the laminate structure. US 2016/0146185 A1 discloses that the pultruded elements of the spar cap can have a tapered end profile and can be arranged with the tapered ends facing in the chordwise or spanwise direction. However, this solution requires a complex and expensive cutting tool with a tapered cutting profile.

Another way to solve this problem is to reduce the thickness of the respective dry plies that makes up the tapered end of the laminate, however, this increases the total number of plies needed as well as increases the number of lay-up steps. Thereby, increasing production time and production costs.

Yet another way to solve this problem is to perform a tapered cut through the thickness of the ply, as mentioned in EP 1786617 B2, disclosing various profiles of the tapered cut. One or two rotating cutting tools, each having a tapered cutting profile, is used to cut the ply into the desired tapered profile. Another cutting apparatus is disclosed in EP 2106315 B1, where the ply is fixed by two sets of fixing means and a pressing beam is moved into contact with the ply thus tensioning the ply and changing the cutting angle of the cutting tool relative to the surface of the ply. A similar cutting apparatus is disclosed in EP 2598316 A1, where the cutting tool is positioned at an acute angle relative to the ply which is supported by a roller and fixed under tension. However, all these solutions increase the complexity of the cutting apparatus as well as increase the total production costs.

US 2011/0143082 A1 discloses an alternative way of solving this problem, where a strip of tape, a bundle of fibre strands, or a filler material is arranged at the terminating edge of the ply to fill up the air pocket fully or partly. However, this introduces additional lay-up steps and adds to the total production time and costs.

US 2011/0143082 A1 also discloses that the fibre ends along the terminating end of the ply may be mechanically worked or bend into a uniform or random orientation deviating from the overall fibre orientation. The fibre ends may be worked using a hammer or an air blower. No cutting of the terminating fibre ends is implied, instead the fibre end must be mechanically bend into the desired shape. This increases the risk of breaking or otherwise damage the fibre ends.

US 2014/0065372 A1 discloses another ply having a terminated end with a continuous triangular, toothed or curved end profile. The end surface along this profile may be angled relative to the thickness direction. A single protrusion or a plurality of protrusions may be arranged along this terminated end. The depth-to-width ratio of each tooth may be between 1:1 to 10:1, and the wave height may be between 10 millimetres to 70 millimetres.

US 2014/0065372 A1 is silent about the production of this modified ply. However, the desired angled profile requires a complex and expensive cutting tool for achieving the desired edge profile. Further, the cuts defining the cutaways are arranged relative to the terminated end independent of the fibre orientation, thus some fibres in multiaxial plies are likely not cut properly which leads to broken fibres in the terminated end area.

### SUMMARY

An object of an embodiment of the invention is achieved by a method of cutting plies for use in a composite laminate of a wind turbine blade, the composite laminate comprising at least one ply of a fibre-reinforced material having at least one terminated edge area with at least one terminated edge, the at least one ply extending in a longitudinal direction and further in a width direction, and comprising fibres extending in at least one fibre direction, wherein the method comprises:
performing a number of local first cuts in the at least one terminated edge area along at least one first cutting line arranged relative to the at least one fibre direction, thereby shortening a percentage of the fibres located along the at least one first cutting line and thus forming a number of cut-off fibre ends;
removing the cut-off fibre ends from the at least one terminated edge area.

This provides a fast and simple production of a modified ply with reduced ply drop effect. One or more edges of the ply are modified to form one or more chamfered edges, which can be adapted to match any desired dry drop requirements.

The cutting in a first direction is performed in the terminated edge area using standard cutting tools or a cutting apparatus as described later. This first cutting of the ply is performed prior to or during the lay-up process. The plies may be prepared, e.g., cut into length and/or modified along one or more edges, in a processing area located separately from the mould. The modified plies may be then transferred into the mould. Alternatively, the plies may be cut and/or modified as they are laid up in the mould.

After the first cutting, the cut-off fibre ends are removed from of the terminated edge area of the ply. Alternatively, some of the cut-off fibre ends may be removed while some cut-off fibre ends may remain in the terminated edge area.

The plies, modified as well as unmodified, may be transferred from the processing area to the moulding area, either stacked together or individually. The plies are arranged on top of each other in accordance with a predetermined lay-up order.

In one embodiment, the local first cuts are performed along a plurality of first cutting lines arranged relative to the at least one fibre direction, preferably the first cuts of one cutting line are offset relative to the first cuts of another cutting line in the at least one fibre direction.

The local first cuts may be performed along a single first cutting line extending in the first cutting direction. Alternatively, the first cuts may be performed along two or more first cutting lines. The first cutting lines may be arranged parallel to each other. The first cutting lines may also be grouped together where each group of first cutting lines may be arranged at an angle relative to another group of first cutting lines. The angle being selected between 0-180 degrees. Each group may comprise one or more first cutting lines. For example, the individual first cutting lines or group of first cutting lines may be angled so that the first cuts may be performed perpendicularly to the fibre direction(s) of the fibres in the ply. This allows the fibres intersecting with the local first cuts to be shortened.

The first cutting line(s) may be located at a distance from the terminated edge. If more than one first cutting line is used, then the individual first cutting lines or groups of first cutting lines may be located at different distances from the terminated edge. The number of first cutting lines and the distances thereof may be adapted to match the desired ply drop requirements.

The longitudinal direction of the ply may define a main fibre direction, e.g., zero degrees, and the fibres may be orientated relative to this main fibre direction. The fibres may extend in the same or different fibre directions each angled relative to the main fibre direction. The first cutting lines, or groups thereof, may further be arranged at an angle relative to the main fibre direction. The orientation of the first cuts may thus be adapted to the individual fibre orientations within the ply. This allows for a proper cut of the fibres.

The individual first cuts at one first cutting line may be aligned with the individual first cuts at another first cutting line in the longitudinal direction and/or the width direction. Alternatively, the first cuts at one first cutting line may be offset, either partly or fully, relative to the first cuts at another first cutting line. The first cuts together form a first cut pattern, where the first cut may be offset or aligned relative to each other. This allows for an adaptive design of the cutaways as the first cut pattern is simply adjusted to meet the chamfering requirements.

In a special embodiment, the percentage of the fibres being cut during the cutting is selected between 5% to 50% for each first cutting line.

The percentage of fibres being cut along each cutting line during the first cutting may be determined by the profile of the cutting edge of the cutting tool. The profile of the cutting edge may be selected to cut all the fibres located at the first cuts. Alternatively, the profile of the cutting edge may be selected to cut a fraction of the fibres while leaving the other fibres uncut. The percentage of cut fibres along each first cutting line may be determined as the sum of cut fibres relative to the total number of fibres, uncut as well as cut, located along the length of the cutting line. The length being measured within the terminated edge area. The percentage may be selected between 5% to 50%, preferably between 5% to 35%, 20% to 50%, or any subranges between 5% to 50%. The number of uncut fibres may thus be gradually reduced towards the terminated edge, if the first cuts are made along multiple first cutting lines. This allows for a more user-friendly cutting process which is more layup robust compared to other cutting methods.

In one embodiment, the at least one ply further comprising stitching yarns extending in a yarn direction, wherein the method further comprises:
performing a number of local second cuts along at least one second cutting line relative to the at least one fibre direction in the at least one terminated edge area, thereby cutting the stitching yarns located at the local second cuts to form a number of cut-off stitching yarn pieces;
removing at least a portion of the cut-off stitching yarn pieces from the at least one terminated edge area.

Further cutting in a second direction may be performed in the terminated edge area using standard cutting tools or a cutting tool as described later. This second cutting of the ply may also be performed prior to or during the lay-up process.

The second cutting may be used to cut one or more stitching yarns arranged in the ply to form a number of cut-off stitching yarn pieces. The stitching yarns may extend in one or more yarn directions that differ from the fibre direction(s). Preferably, the local second cuts are located relative to (e.g., adjacent to or near) the local first cuts. This allows the stitching yarns located at the local second cuts to be cut so that all or some of the cut-off stitching yarn pieces can be removed from the ply, e.g., together with the cut-off fibre ends.

Preferably, at least the portion of stitching yarn pieces located in the cut-off fibre ends, or the intended cutaways, may be removed. Thereby leaving the portion of stitching yarn pieces located in the uncut fibres remain in the terminated edge area. Thus, maintaining the fibre orientation of the uncut fibres. Alternatively, the stitching yarn pieces located in both the cut-off fibre ends, or the intended cutaways, and the uncut fibres may be removed. This allows the uncut fibres and some of the shortened fibres to blend and partly extend into the cutaways.

When combined, the first cuts and the second cuts form a cutting pattern, which can simply be adapted to meet different chamfering requirements.

In one embodiment, the local second cuts are performed along a plurality of second cutting lines arranged relative to the at least one terminated edge, preferably the second cutting lines being parallel relative to each other.

The local second cuts may be performed along at least one second cutting line extending in the second cutting direction. Alternatively, the second cuts may be performed along two or more second cutting lines. The second cutting lines may be arranged parallel to each other. The second cutting lines may alternatively be grouped together where each group of second cutting lines may be arranged at an angle relative to another group of second cutting lines. The angle being selected between 0-180 degrees. For example, the individual second cutting lines, or groups thereof, may be angled so that the second cuts may be performed perpendicularly to the yarn direction(s) in the ply. This loosens the tension on the fibres and allows the cut-off stitching yarn pieces and cut-off fibre ends to be removed.

The individual second cuts at one second cutting line may be aligned with the individual second cuts at another second cutting line in the longitudinal direction and/or the width direction. Alternatively, the second cuts at one second cutting line may be offset, either partly or fully, relative to the second cuts at another second cutting line. The second cuts together form a second cut pattern, where the second cut may be offset or aligned relative to each other.

The first and second cuts may form a number of cutaways, each having a cutaway profile defining a local width and a local length. The local width may be measured in the width direction and the local length may be measured in the longitudinal direction. The cutaway profile, the local width and/or the local length may be adapted to match the desired ply drop requirements.

In one embodiment, the step of performing the local second cuts is performed either prior to or after the step of performing the local first cuts.

The order in which the cutting as well as the removal of the cut-off pieces are performed may vary. For example, the first cutting may be performed before the second cutting, or vice versa. For example, the removal of the cut-off stitching yarn pieces may be performed before the removal of the cut-off fibre ends, or vice versa. For example, the first cutting and the removal of the cut-off fibre ends may be performed after the second cutting and the removal of the cut-off stitching yarn pieces.

Removing the stitching yarns before cutting the fibres, enables the fibres to bend as the cutting tool is moved through the ply. Thereby, some fibres may bend around the cutting tool while other fibres may be cut by the cutting tool. This also reduces the risk of the fibres breaking during the cutting. Removing the stitching yarns after cutting the fibres, enables the cutaways to be removed in one piece.

In one embodiment, the first cuts and the second cuts are performed simultaneously, and/or the removing of the cut-off fibre ends and the cut-off stitching yarn pieces are performed simultaneously.

The first and second cutting may advantageuously be performed in the same step using the same cutting tool. Alternatively, the first and second cutting may be performed individually in separate sub-steps. This saves time as no complex or tapered cutting is needed.

Preferably, the cut-off fibre ends and the cut-off stitching yarn pieces may be removed from the ply in the same step. This allows the cut-off pieces to be removed in one step, thus further saving time.

Further, one or more shortened stitching yarns located between the cutaways may be removed from the ply. The shortened stitching yarns and/or the one or more uncut stitching yarns may be removed in a separate step or together with the cut-off fibre ends and/or the cut-off stitching yarns. This allows the fibres, i.e., uncut fibres and shortened fibres, in the terminated edge area to blend more uniformly around the cutaways.

The removal of the abovementioned cut-off pieces and the removal of the abovementioned stitching yarns may be performed using different techniques or tools. Alternatively, the removal of the cut-off pieces and the stitching yarns may be removed using the same technique or tool.

In one embodiment, at last the first cuts are performed perpendicularly relative to an outer surface of the at least one ply through a thickness of the at least one ply.

The first and, optionally, the second cuts may advantageously be made by performing a straight cut through the thickness of the ply. The straight cut being perpendicular to an outer surface of the ply, e.g., the top or bottom surface. No need for a complex cutting tool or tapered cut as mentioned in e.g., EP 1786617 B2 or EP 2106315 B1. This allows for a simple and easy cut thus saving cutting time and costs.

In one embodiment, the method further comprises:
mixing the shortened fibres with the uncut fibres along the at least one terminated edge area in random fibre directions.

The shortened fibres and the uncut fibres may be mixed in random fibre directions in a final step of the method. During mixing, the shortened or uncut fibres may bend into the cutaways, e.g., some fibres may bend in one direction while other fibres may bend in the opposite direction. The mixing may be performed by a mechanical interaction or by applying a forced air flow. Thus, fewer fibres will end at the same location, which enables the chamfering of the ply to be adapted to match the ply drop requirements.

This final step may be performed at a separate working station before the ply is transferred to the mould. The final step may also be performed at the mould during or after the lay-up of the ply. The order in which the individual steps of the present method are performed may advantageuously be adapted to comply with the desired lay-up process and lay-up system.

Optionally, the mixed fibres along the terminated edge area may be held in place by one or more clamping elements or devices during the transfer from the working to the mould. The clamping element may in example be a flexible or rigid rod or bar with soft paddings, but other configurations may also be used. The clamping device may comprise an upper clamping element that fixates the modified ply against the cutting base or a lower clamping element. This allows the mixed fibres to be held in place during the transfer, if needed.

In one embodiment, the method comprises further removing one or more uncut stitching yarns from the at least one terminated edge area.

The terminated edge area may further comprise one or more uncut stitching yarns extending the length of the terminated edge area. These uncut stitching yarns may also be removed so that the terminated edge area may be free of stitching yarns. This allows the uncut fibres and the shortened fibres to better bend and thus mix along terminated edge area. The fibres are then less likely to break during bending.

Alternatively, these uncut stitching yarns may also be cut during the second cutting. The cut-off stitching yarn pieces may then be removed together with the rest of the other cut-off stitching yarn pieces. This allows for all the stitching yarns to be removed from the terminated edge area.

In one embodiment, the removing of the cut-off fibre ends, the cut-off stitching yarn pieces and, optionally, the uncut stitching yarns; and/or the mixing of the shortened fibres and the uncut fibres are performed by mechanical interaction with the least one ply or by applying a forced air flow to the least one ply.

The cut-off pieces, i.e., the cut-off fibre ends and the cut-off stitching yarn pieces, and the optional uncut stitching yarns may be removed from the terminated edge area by mechanical interaction. One or more mechanical devices may be used to interact with the ply to remove the cut-off pieces. For example, a handheld mechanical device may be operated by the worker to manually remove the cut-off pieces. Instead, the mechanical device may be integrated into or connected to the cutting apparatus and used to remove the cut-off pieces. The mechanical device may comprise one or more elements adapted to interact with the ply to remove the cut-off pieces in the ply.

For example, the cut-off pieces in the terminated edge area may be removed by combing, brushing or another type of mechanical interaction. This may be achieved by moving one or more rows/groups of teeth, bristles or nails of the mechanical device through the fibres in the terminated edge area. The rows or groups of interacting elements may be moved linearly along the ply towards the terminated edge or be rotated into interaction with the ply. This allows for easy and cheap way of removing the cut-off pieces.

Alternatively or additionally, a forced air flow may be applied to the terminated edge area to remove the cut-off pieces. This may be achieved by means of an air system configured to generate a negative air pressure (suction) or a positive air pressure (air flow) at the outer of the ply. The air system may for example be coupled to or integrated into the cutting apparatus. The air system may comprise an air trap or filter to collect the cut-off pieces. This allows for a simple and effective removal of the cut-off pieces.

Optionally, the mechanical device and/or the air system may also be used to mix the shortened and uncut fibres as mentioned above. For example, the shortened and uncut fibres may be mixed randomly while removing the cut-off pieces, e.g., by means of the air system. This reduces the total process steps and saves time.

Optionally, the mechanical device may be used to remove the cut-off stitching yarn pieces and/or the cut-off fibre ends from the ply while the air system may be used to hold the ply in place during cutting and/or to remove the cut-off pieces from the cutting tool.

An object of an embodiment of the present invention is also achieved by a composite laminate of a wind turbine blade, the composite laminate comprising at least one ply formed by a fibre-reinforced material having at least one terminated edge area with at least one terminated edge, the at least one ply extending in a longitudinal direction and further in a width direction, and the fibres being arranged in at least one fibre direction, wherein the at least one ply along the at least one terminated edge area comprising fibres locally shortened at a number of local first cuts extending along at least one first cutting line and locally uncut fibres extending along the terminated edge, wherein the locally shortened fibres are formed by shortening a percentage of the fibres at the local first cuts.

This provides a ply with a chamfered edge profile that can be produced using a cutting method as mentioned above. The present chamfered edge design is flexible and can be adjusted to match any ply drop requirements. This allows for the use of thicker plies in the composite laminate, the thicker plies having a higher weight per square meter (GSM) value. For example, the plies of an embodiment of the present invention may have a GSM value of 1250 or higher, preferably a GSM value between 1500 to 1800 or even a GSM value higher than 1800. This in turn allows a composite laminate with lower resin absorption and higher E-modulus. Thereby reducing the total number of layers in the laminate as well as reducing the total number of layup-runs during the manufacture process. This may also lower the layup cycle time and lower the total production costs.

The present composite laminate comprises a plurality of plies arranged on top of each other in a predetermined order to form a stacked structure. The composite laminate comprises one or more modified plies having a chamfered edge profile, as described above, and one or more unmodified plies. Alternatively, all the plies of the composite laminate have a chamfered edge profile.

The stacked plies together form a tapered edge profile of the composite laminate extending in the longitudinal direction and/or in the width direction. The tapered edge may extend partly or fully along one or both ends and/or one or both sides of the composite laminate. The tapered edge profile may be defined by at least the chamfered edge profiles of the modified plies, thus allowing the tapered edge profile to be adapted to match the geometric profile of the wind turbine blade.

The ply may comprise unidirectional (UD) fibres, biaxial fibres, triaxial fibres or multidirectional fibres. For example, the UD-fibres may be arranged in the longitudinal direction. For example, the biaxial fibres may be arranged at +45°/−45° or 0°/90° relative the main fibre direction. The fibres may be made of glass, carbon, aramid or an organic material, such as hemp, flax and jute.

The ply comprises one or more terminated edge areas extending in the width direction and further in the longitudinal direction. Each terminated edge area has a local width measured in the width direction and a local length measured in the longitudinal direction. The local width and/or the local length may be adapted to match any ply drop requirements. For example, the local width of the terminated edge area may be 200 mm, preferably 100 mm, preferably 50 mm measured from the terminated side edge. For example, the local length of the terminated edge area may be 200 mm, preferably 100 mm, preferably 50 mm measured from the terminated end edge.

In one embodiment, the fibres are locally shortened along a plurality of first cutting lines arranged relative to each other, each first cutting line define a local length of the first cuts located along that first cutting line.

The fibres in the terminated edge area may be cut along a single or multiple first cutting lines to form shortened fibres of the same length or different lengths. The distance from the individual first cutting lines to the terminated edge may indicate the local length of the individual cutaways. The distance may be adapted to alter the profile of the cutaways. This allows for a flexible chamfering of the terminated edge that can be adapted to match the ply drop requirements.

In one embodiment, the locally shortened fibres and the locally uncut fibres are mixed along the at least terminated edge area in random fibre directions; and/or the total number of shortened fibres at each first cutting line increases towards the terminated edge.

The ply may for example comprise shortened fibres and uncut fibres which are mixed in random fibre directions. All or some of the shortened and uncut fibres may bend in the terminated edge area so they at least partly extend into the cutaways. The bending radius thereof may be selected between 0 to 50 degrees, preferably between 20-40 degrees, relative to the original fibre direction. This allows for a more uniform distribution of the fibres along the terminated edge.

Alternatively or additionally, the ply may comprise a number of shortened fibres and a number of uncut fibres at each first cutting line. The number of shortened fibres may increase from an innermost first cutting line to an outermost first cutting line. Thus, the number of uncut fibres may decrease from the innermost first cutting line to the outermost first cutting line. This allows the density of fibres to gradually decrease towards the terminated edge, which in turn defines the chamfering edge profile.

In one embodiment, at least a local width or a local length of the local first cuts is uniform or varies along the at least one terminated edge area.

The chamfered edge profile has a local width measured in the longitudinal or width direction, a local thickness measured in the thickness direction, and a local length measured along the terminated edge. The ratios thereof may be adjusted to meet different ply drop requirements.

The ply may be produced with a uniform edge profile extending along the terminated edge area. This allows for a fast and easy cutting of the ply. The ply may also be produced with an edge profile that varies along the terminated edge area. For example, the local width and/or local length of the individual cutaways may vary continuously or in steps along the terminated edge area. This allows the chamfering of the edge area to vary along the terminated edge.

Further, the local width and/or the local thickness may be varied between different plies of the composite laminate. Similarly, the local thickness may also be varied between different plies of the composite laminate. This allows for a flexible design of the tapered edge profile as the cutting apparatus can easily be adjusted to the different cutting patterns for each ply.

In one embodiment, a local width(s) between adjacent local first cuts are uniform or varies along the at least one terminated edge.

The local width between the individual cutaways may vary or be uniform along the terminated edge area. For example, the local width may be varied in steps or continuously along the terminated edge area. This also allows for a flexible chamfering of the edge area.

Embodiments of the present invention allow for the use of different plies with different chamfering of the terminated edge. The chamfering of the individual plies in the composite laminate may thus be adapted to an improved tapered edge profile. This is advantageous in blade sections where the thickness of the composite laminate is intended to taper off towards the tip end, the root end, the trailing edge and/or the leading edge.

The composite laminate may form a spar cap element, either laid up directly in the blade mould or in a separate mould. The composite laminate may also form another component of the wind turbine blade, such as a shell portion, a reinforcing web, a root end, or another blade component.

Preferably, the terminated edge may be located at one or both ends of the ply, the ends may extend in the width direction. Alternatively or additionally, the terminated edge may also located at one or both side edges of the ply, e.g., towards the one end. This allows the thickness of the composite laminate to taper off in the longitudinal direction and/or in the width direction depending to desired application.

An object of an embodiment of the invention is further achieved by a cutting apparatus for cutting plies of a composite laminate for a wind turbine blade, comprising:
a cutting base with a top surface on which at least one ply of a fibre-reinforced material can be positioned, the at least one ply comprising fibres extending in at least one fibre direction;
at least one cutting tool arranged relative to the cutting base and configured to perform a number of local first cuts along at least one first cutting line in the at least one ply, thereby shortening a percentage of the fibres located along the at least one first cutting line and thus forming a number of cut-off fibre ends;
optionally, at least one fixing unit arranged relative to the base, wherein the at least one fixing unit is configured to hold the at least one ply in position relative to the at least cutting tool; and
means configured to remove at least the cut-off fibre ends from the at least one ply after cutting.

This provides a cheap and simple cutting apparatus for modifying the terminated edge of the ply, as mentioned above. No need for a complex cutting tool. This also reduces the total number of moveable parts.

The cutting apparatus may comprise a cutting base on which the ply may be positioned. The dimensions of the cutting base may be selected to correspond to at least the width of the ply. One or more cutting tools may be positioned above the cutting base to perform the cutting of the fibres and optionally the stitching yarns. The cutting tools may be operated automatically or manually. Optionally, the cutting base may comprise a transport or endless belt arranged to feed the ply into and out of the cutting apparatus, either from one end or opposite ends. This allows for use of a cutting apparatus where the ply is fed into and out of the cutting apparatus.

The cutting apparatus may be adapted to be positioned at a separate working station or be attached to the mould relative to the moulding surface. The cutting apparatus may thus be configured as a stationary unit allowing the ply to be cut in a controlled environment.

Alternatively, the cutting apparatus may be configured as a moveable unit capable of being moved into position relative to a selected ply. The cutting apparatus may be configured as a standalone unit or as an attachment for an automated layup unit. The standalone or layup unit may be coupled to and powered by a robotic unit, a gantry system or an overhead crane system. This allows the cutting apparatus to interact with an automatic layup system or a gantry or crane system arranged relative to the mould during the layup process.

Alternatively, the cutting apparatus may also be configured as a handheld tool capable of being manually operated by the workers during the layup process. The cutting apparatus may be driven by an internal energy source or be an external energy source. The handheld tool may be positioned relative to and moved along the terminated edge area to perform the cutting process. This allows the workers to perform the cutting after the layup of the ply.

In one embodiment, the at least one cutting tool comprising a plurality of first cutting elements arranged in at least one first cutting direction, the first cutting elements being configured to perform the local first cuts perpendicularly through the at least one ply.

The cutting tool may comprise one or more cutting elements configured to perform one or more local cuts in the first and/or second cutting direction. The cutting elements may be selected from knives, cutting wheels, cutting dies, ultrasound cutters, oscillating knives or any other suitable cutting elements. The cutting elements may be configured to perform one or more straight cuts in the thickness direction of the ply. This allows for a simple cutting tool as no tapered cuts are needed.

The cutting element each has a cutting edge adapted to cut the fibres and/or stitching yarns of the ply. The cutting edge may have a straight profile, a curved profile, a triangular profile or another suitable profile. This allows for an optimal cut of the fibres.

The cutting tool preferably comprises a plurality of first cutting elements configured to perform the individual first cuts along the first cutting lines. The first cutting elements may be arranged in one or more rows or group to form the first cut pattern, as mentioned above. Each row or group of first cutting elements may be operated independently or simultaneously via a hydraulic, electrical, or pneumatic power unit or via a manually operated moving mechanism. The first cutting elements may be adjustable or interchangeable so they can be adapted to different cut patterns. This allows for a simple and fast first cutting where the first cuts are made manually or automatically.

In one embodiment, the at least one cutting tool further comprising a plurality of second cutting elements arranged in at least one second cutting direction, the second cutting elements are configured to perform a number of local second cuts through the at least one ply.

The cutting tool may further comprise a plurality of second cutting elements configured to perform the individual second cuts along the second cutting lines. The second cutting elements may be arranged in one or more rows or group to form the second cut pattern, as mentioned above. Each row or group of second cutting elements may be operated independently or simultaneously, e.g., via the same power source as the first cutting elements or a separate power source. The second cutting elements may be adjustable or interchangeable so they can be adapted to different cut patterns. This allows for a simple and fast second cutting where the second cuts are made manually or automatically.

The first and second cutting elements define the local width and the local length of the cutaways as well as the local width between the individual cutaways.

In one embodiment, at least the first cutting elements or the second cutting elements are arranged on at least one cutting die, preferably a rotary die or a plate shaped die, the at least one cutting die is configured to be moved into contact with the at least one ply.

The first and second cutting elements may be arranged on separate cutting dies, each cutting die may be configured differently. Preferably, the first and second cutting elements may be arranged on a common die. The cutting die(s) being connected to the above power unit or moving mechanism. This allows for a fast and simple cutting of the fibres and stitching yarns.

The cutting die may be configured as a plate shaped die or a rotary die on which the individual cutting elements may be arranged. The plate shaped die may be moved, e.g., by a punching mechanism, perpendicularly relative to the outer surface of the ply to perform the local cuts. The rotary die may be moved parallel relative to the outer surface of the ply, or vice versa, to perform the local cuts. This allows for a simple and cheap configuration of the cutting tool.

In one embodiment, at least the first cutting elements each has a cutting edge with an edge profile, the edge profile being selected to cut a predetermined percentage of the fibres located along the at least one first cutting line during the cutting.

The edge profile of each first cutting element may be selected so that it cuts a predetermined percentage of the fibres located at that first cut during the cutting process. For example, the edge profile may have a curved, triangular, elliptic, or polygonal shape projecting outwards from a straight line of the cutting edge. The angle or radius of the edge profile may be selected in accordance with the number of fibres intended to be cut along that cutting line during the cutting. The edge profile may be selected to cut a fraction of the fibres, thus leaving some fibres uncut, as mentioned earlier. The edge profile may also be selected to cut all the fibres.

In one embodiment, the means configured to remove at least the cut-off fibre ends is a mechanical system configured to interact with the at least one ply or an air system adapted to apply a suction or forced air onto the at least one ply.

The cutting apparatus may comprise one or more mechanical devices for removing the cut-off pieces, arranged relative to the cutting tool. The device may comprise one or more sets of projecting elements, such as, brushes, combs, needles, nails or teeth, which can be moved into engagement with the ply and moved along the terminated edge area. The ply may be moved relative to the stationary elements, or vice versa, to remove the cut-off pieces. The elements may also be configured as rotatable elements that can be rotated into engagement with the ply. The ply may be fixed during this removal process so that the cut-off pieces can be removed.

The means for removing the cut-off pieces may also be an air system configured to apply a forced air flow or a suction at the outer surface of the ply. The air system may comprise a fan or pump to generate the air flow or suction, where an air outlet/inlet may be arranged above the cutting base or integrated into the cutting base. The air outlet or air inlet may be in fluid communication with an air trap or filter to collect the cut-off pieces. This allows the cut-off pieces to be removed using a flow of air.

Optionally, the air system and the mechanical device may be used in combination to effectively remove the cut-off pieces. For example, the rotatable elements may be provided on a cylinder with a plurality of air inlets, where air and cut-off pieces are drawn into the interior of the cylinder and removed from the cutting tool. For example, the rotatable elements may be provided on a cylinder where a separate brush is used to remove the cut-off pieces from the rotatable elements.

The air system and/or the mechanical device may further be used to mix the shortened fibres and the uncut fibres in random fibre directions. This allows the removal of cut-off pieces and the random mixing of the fibres to be performed in the same step, thereby saving time.

The air system may optionally also be used to hold the ply in place during the cutting. One or more suction inlets may be arranged in the contact surface of the cutting base and in fluid communication with the air system. A suction pressure may be applied before the cutting starts and may be terminated after the cutting is completed.

In one embodiment, the at least one fixing unit comprises a mechanical fixing element or an air system adapted to apply a suction onto the at least one ply.

The cutting apparatus may comprise one or more fixing elements configured to mechanically fix the ply relative to the cutting base. For example, the fixing elements may be one or more flexible or inflatable elements, rigid elements, straps, caterpillar belts or the like capable of fixating the ply during the cutting.

Alternatively, the above air system or another air system may be used to fix to the ply onto the cutting base. The air system may be integrated into the cutting apparatus to form a compact unit or be coupled to the cutting apparatus for saving space.

An object of the disclosure is further achieved by a wind turbine blade of a wind turbine, wherein the wind turbine blade comprises a composite laminate as described above.

### DESCRIPTION OF THE DRAWINGS

Embodiments of the invention are described by example only and with reference to the drawings, wherein:

FIG. 1 shows an exemplary embodiment of a wind turbine,

FIG. 2 shows an exemplary embodiment of the wind turbine blade,

FIGS. 3A and 3B show a modified ply and a composite laminate according to an embodiment of the invention,

FIG. 4 shows a modified ply with multiple first and second cutting lines,

FIG. 5 shows a first and a second cutting element,

FIG. 6 shows various shapes of the cutting edge,

FIG. 7 shows a first embodiment of the cutting apparatus in an open state,

FIG. 8 shows the cutting apparatus of FIG. 7 in a closed state,

FIG. 9 shows a second embodiment of the first cutting element,

FIG. 10 shows a third embodiment of the first and second cutting elements,

FIG. 11 shows a second embodiment of the cutting apparatus,

FIG. 12 shows a fourth embodiment of the first cutting element during cutting,

FIG. 13 shows the first cutting element and ply after the cutting,

FIG. 14 shows various profile of the cutting edge,

FIG. 15 shows three plies with different fibre orientations,

FIG. 16 shows a cutting pattern for performed the first cutting of the ply, and

FIG. 17 shows the ply of FIG. 15 after the first cutting.

In the following text, the figures will be described one by one, and the different parts and positions seen in the figures will be numbered with the same numbers in the different figures. Not all parts and positions indicated in a specific figure will necessarily be discussed together with that figure.

### REFERENCE LIST

1. Wind turbine
2. Wind turbine tower
3. Nacelle
4. Yaw mechanism
5. Wind turbine blades
6. Rotor hub
7. Pitch mechanism
8. Tip end, second end
9. Blade root, first end
10. Leading edge
11. Trailing edge
12. Spar cap
13. Plies
14. Longitudinal direction
15. Width direction
16. Terminated edge area
17. Terminated edge
18. Thickness direction
19. First cutting lines
20. Second cutting lines
21. Cutaways
22. Cutting dies
23. First cutting elements
24. Cutting edge
25. Cutting apparatus
26. Cutting tool
27. Second cutting elements
28. Needles
29. Upper support structure
30. Lower support structure
31. Stitching yarns
32. Cutting element
33. Roll of ply
34. Cutting base
35. Comb
36. Fixing element
37. Fibres
38. First cuts
39. Main fibre direction
40. Cutting pattern

### DETAILED DESCRIPTION OF THE EMBODIMENTS

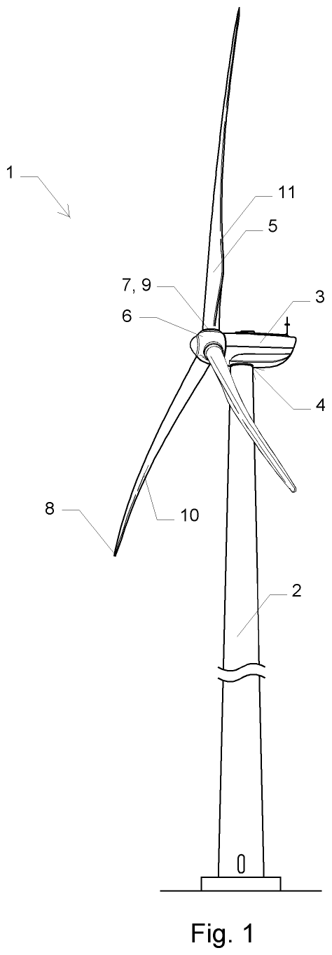

FIG. 1 shows a wind turbine 1 comprising a wind turbine tower 2 and a nacelle 3 arranged on top of the wind turbine tower 2 using a yaw mechanism 4. The yaw mechanism 4 is configured to yaw the nacelle 3 into a yaw angle. A rotor comprising at least two wind turbine blades 5 mounted to a rotor hub 6 via a pitch mechanism 7. The pitch mechanism 7 is configured to pitch the wind turbine blades 5 into a pitch angle. The rotor hub 6 is rotatably connected to a generator arranged in the wind turbine 1 via a rotor shaft.

Each wind turbine blade 5 comprises a tip end 8 and a blade root 9, wherein the wind turbine blade 5 has an aerodynamic profile defining a leading edge 10 and a trailing edge 11.

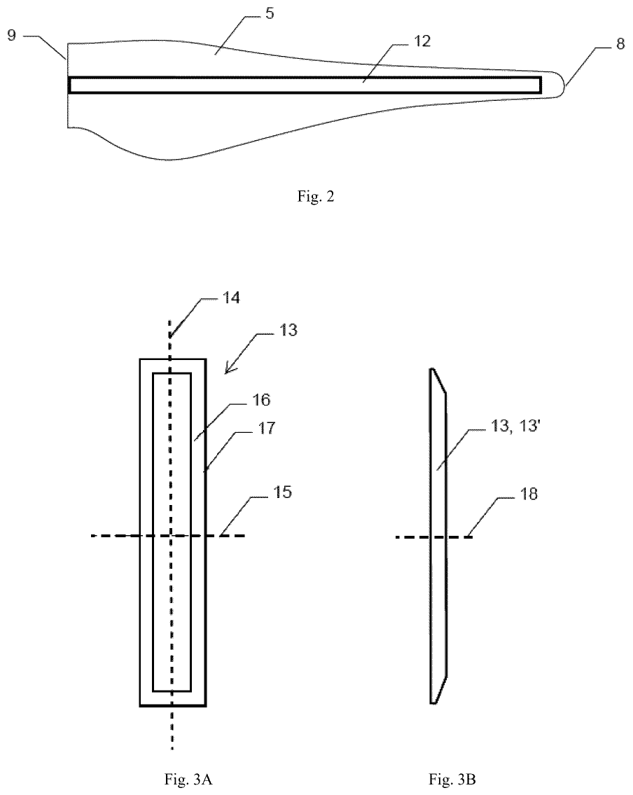

FIG. 2 shows an exemplary embodiment of the wind turbine blade 5 where the wind turbine blade 5 is shaped as a full-span blade. The wind turbine blade 5 may also be a partial-pitch blade. The wind turbine blade 5 comprises a spar cap 12 extending from a local first end facing the root end 9 to a local second end facing the tip end 8.

FIG. 3A shows a ply 13 of a composite laminate according to an embodiment of the invention. The ply 13 is made of a fibrous material and comprises fibres extending in one or more fibre directions. The ply 13 extends in a longitudinal direction 14 and further in a width direction 15.

The ply 13 comprises a terminated edge area 16 with a terminated edge 17. The terminated edge 17 is here arranged at both ends of the ply 13 but could be arranged at only one end of the ply 13. The terminated edge 17 is further arranged at both sides of the ply 13 but could be arranged at only one side of the ply 13. The terminate edge 17 may also be arranged only at one end of the ply 13.

FIG. 3A shows the ply 13 chamfered along the terminated edge area 16 so the local thickness at the terminated edge 17 is reduced in the thickness direction 18. The composite laminate comprises a plurality of plies 13 and unmodified plies 13′ are arranged on top of each other to a stacked structure, as illustrated in FIG. 3B, with one or more tapered edges.

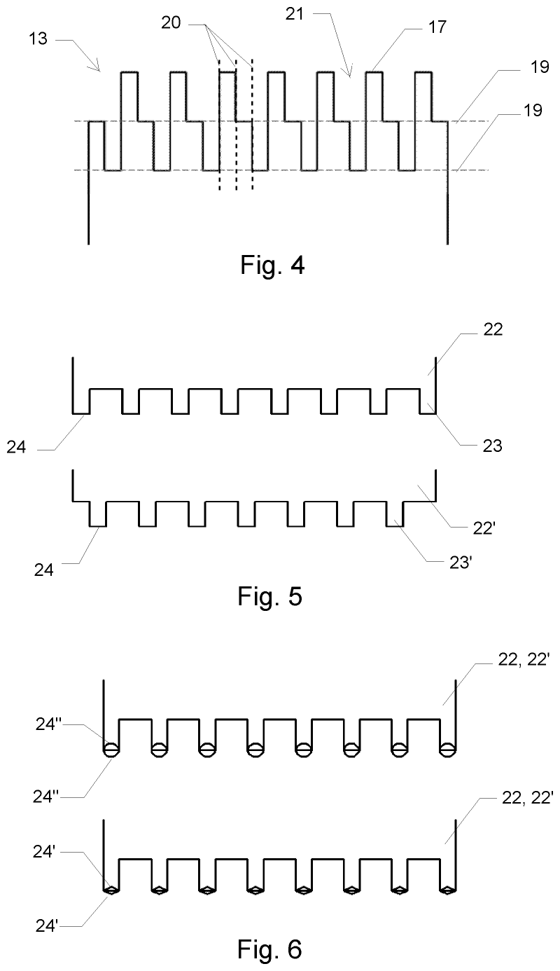

FIG. 4 shows the ply 13 modified in the width direction 15 along one end. A plurality of first cutting lines 19 are arranged in a first cutting direction relative to the terminated edge 17. Here, the fibre direction is perpendicular to the terminated edge 17. A plurality of local first cuts are performed along the first cutting lines 19 to shorten the fibres located at each first cut in the fibre direction.

Further, a plurality of second cutting lines 20 are arranged in a second cutting direction relative to the terminated edge 17. Here, the second cutting lines 20 are perpendicular to the fibre direction. A plurality of local second cuts are performed along the second cutting lines 20 to cut the stitching yarns extending in a yarn direction.

Here, multiple first and second cutting lines 19, 20 are shown. However, a single first cutting line 19 and/or a single second cutting line 20 may be used. Further, the first cutting lines 19 and the second could also be arranged an oblique angle relative to the terminated edge 17 depending on the fibre orientation.

The local first and second cuts together form a number of cutaways 21, each having a predetermined profile, width and length.

FIG. 5 shows two cutting dies 22, 22′ with first cutting elements 23, 23′ adapted to make the local first cuts along the different first cutting lines 19 as shown in FIG. 4. Here, the cutting elements 23, 23′ are shaped as teeth. A first cutting die 22 comprises a plurality of first cutting elements 23, each with a cutting edge 24, adapted to cut the fibres in the ply 13 along an outermost cutting line 19. Another first cutting die 22′ also comprises a plurality of first cutting elements 23′, each with a cutting edge 24, adapted to cut the fibres in the ply 13 along an innermost cutting line 19. The first cutting elements 23, 23′ are offset relative to each other, as indicated in FIG. 5.

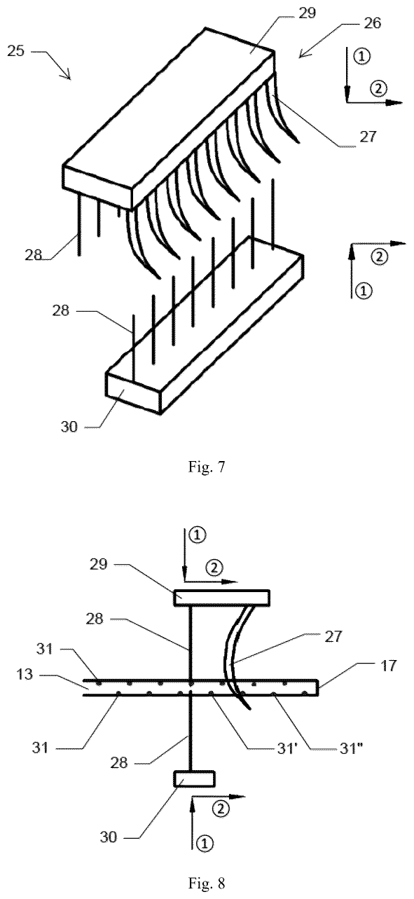

Similarly, a plurality second cutting elements (as illustrated in FIGS. 7-8 and 10-11) is used to make the local second cuts along the second cutting lines 20 shown in FIG. 4.

FIG. 6 shows various shapes of the cutting edge 24 of the first cutting element 23, 23′. The cutting edge 24 may have straight profile (as illustrated in FIG. 5), a triangular profile 24′ or a curved profile 24″ (e.g., circular or elliptical). The cutting edge 24′, 24″ may be curved inwards or outwards relative to the straight profile.

FIG. 7 shows a first embodiment of a cutting apparatus 25 in an open state according to an embodiment of the invention. Here, only the means for removing the cut-off fibres and stitching yarns and the cutting tool are shown.

The cutting tool 26 comprises a plurality of second cutting elements 27, e.g., knives, shaped to cut the stitching yarns in the second cutting direction. The cutting tool 26 further comprises a plurality of first cutting elements (not shown) shaped to cut the fibres in the first cutting direction.

Rows of needles 28 are used to remove the cut-off pieces from the terminated edge area 16. A first row of needles 28 is arranged on an upper support structure 29 and a second row of needles 28 is arranged on a lower support structure 30. The first and second rows of needles 28 are arranged in the cutting apparatus 25 so the ply 13 can be positioned between the first and second rows of needles 28 in the open state. More than one row of needles 28 may be arranged on the lower support structure 30 and/or the upper support structure 29.

The second cutting elements 27 are here arranged on the upper support structure 29. The second cutting elements 27 or another set of second cutting elements may alternatively be arranged on the lower support structure 30.

FIG. 8 shows the cutting apparatus 25 in a closed state, where the first and second rows of needles 28 are moved linearly into engagement with the ply 13, as illustrated by arrow (1). Alternatively, the first and/or second rows of needles 28 are rotated into engagement with the ply 13. This enables the needles 28 to contact the stitching yarns 31 located in the terminated edge area 16 of the ply 13. The second cutting elements 27 are also moved into engagement with the ply 13.

The first and second support structures 29, 30 as well as the second cutting elements 27 are then moved along the ply 13 towards the terminated edge 17, as illustrated by arrow (2). This allows the needles 28 to remove the stitching yarn pieces 31″ cut by the cutting elements 27 as well as one or more uncut stitching yarns 31′ located between the cutting elements 27 and the needles 28.

FIG. 9 shows a second embodiment of the cutting die 22, 22′, where the local width, w, of the cutting elements 23, 23′ are varied along the length of the cutting die 22, 22′. Similarly, the spacing or distance, s, between adjacent cutting elements 23, 23′ are varied along the length of the cutting die 22, 22′. Alternatively, the local width w may be uniform while the distance s is varied, or vice versa.

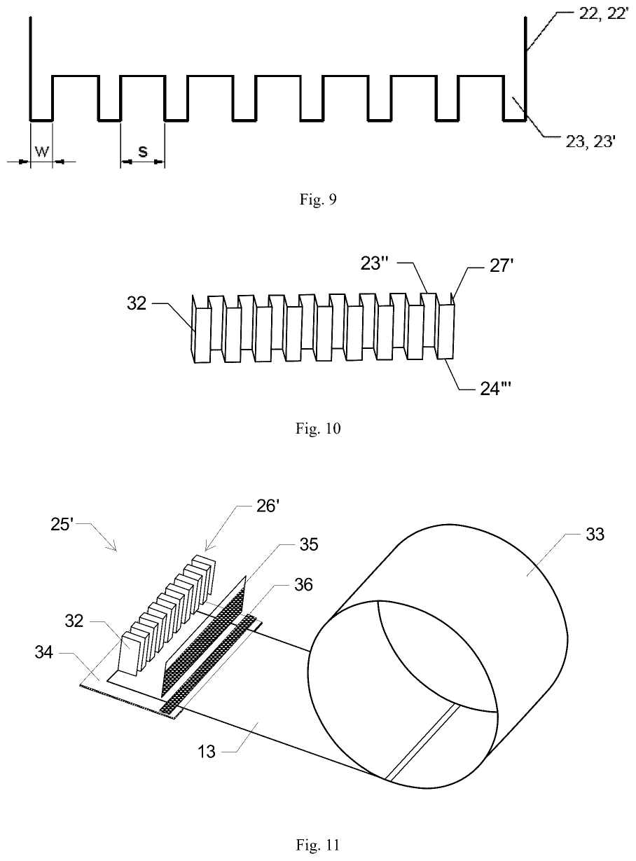

FIG. 10 shows a third embodiment of the first and second cutting elements of the cutting tool 26′. Here, the first cutting elements 23″ and the second cutting elements 27′ are arranged on a combined cutting die 32 with a continuous cutting edge 24″. The cutting die 32 is shaped to match the profiles of the desired cutaways. Here, the cutting die 32 is shaped as plate like die with a stepped cutting edge 24″.

FIG. 11 shows a second embodiment of the cutting apparatus 25′ comprising the cutting tool 26′. Here, the cutting apparatus 25′ is configured as an attachment for an automated lay-up system.

The ply 13 is arranged on a roll 33 positioned relative to cutting apparatus 25′. The ply 13 is then feed into the cutting apparatus 25′ and positioned relative to the cutting tool 26′.

The cutting apparatus 25′ comprises a cutting base 34 adapted to receive the ply 13, wherein the cutting tool 26′ is arranged above the cutting base 34. A comb 35 with a plurality of teeth is further arranged above the cutting base 34. The comb 35 is configured to be moved into engagement with the ply 13 to remove the cut-off pieces. A fixing element 36 is further arranged on the cutting base 34, wherein the fixing element 36 is configured to hold the ply 13 in position on the cutting base 34 during the cutting process.

FIG. 12 shows a fourth embodiment of the first cutting element 23″ during the first cutting. Here, the first cutting element 23″ is moved into interaction with the ply 13 (only the fibres 37 of the ply are illustrated). FIG. 13 shows the first cutting element 23″ and the ply 13 after the cutting.

The profile of the cutting edge 24 is shaped so that it cuts a percentage of the fibres 37 located at the local first cut 38. Here, the edge profile is triangular shaped so a fraction of the fibres 37 are cut.

Once the first cutting is complete, some of the fibres 37 are cut to form shortened fibres 37′ and fibre ends 37″ (dotted lines) while other fibres 37″′ are left uncut.

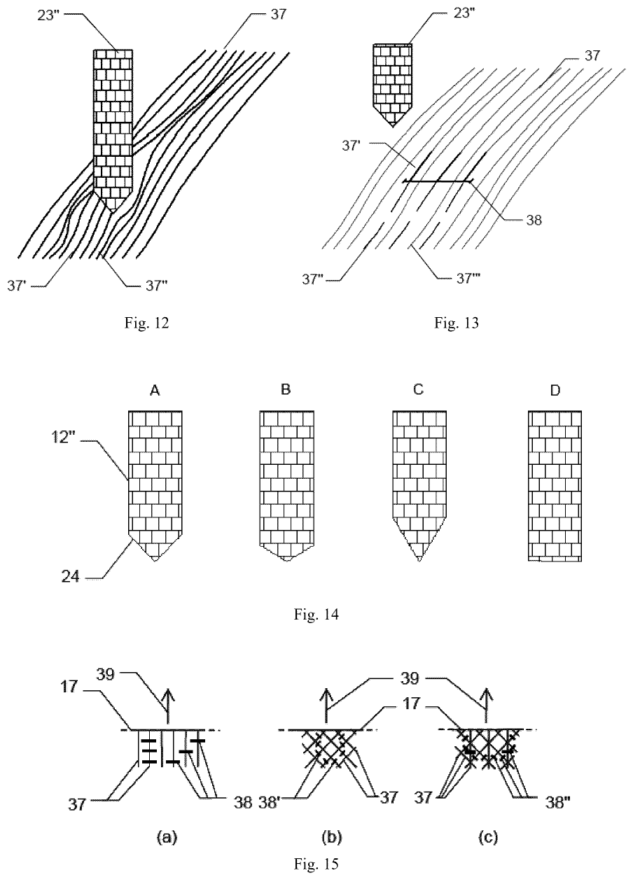

FIG. 14 shows various profiles of the cutting edge 24 of the first cutting element 23″. The angle of the cutting edge 24 is selected depending on the percentage of fibres intended to be cut. If the cutting edge 24 has a low angle, as illustrated in (B), then it will cut more fibres than if a high angle, as illustrated in (C), was selected. A straight cutting edge may be selected to cut substantially all fibres 37 at the local first cut 38.

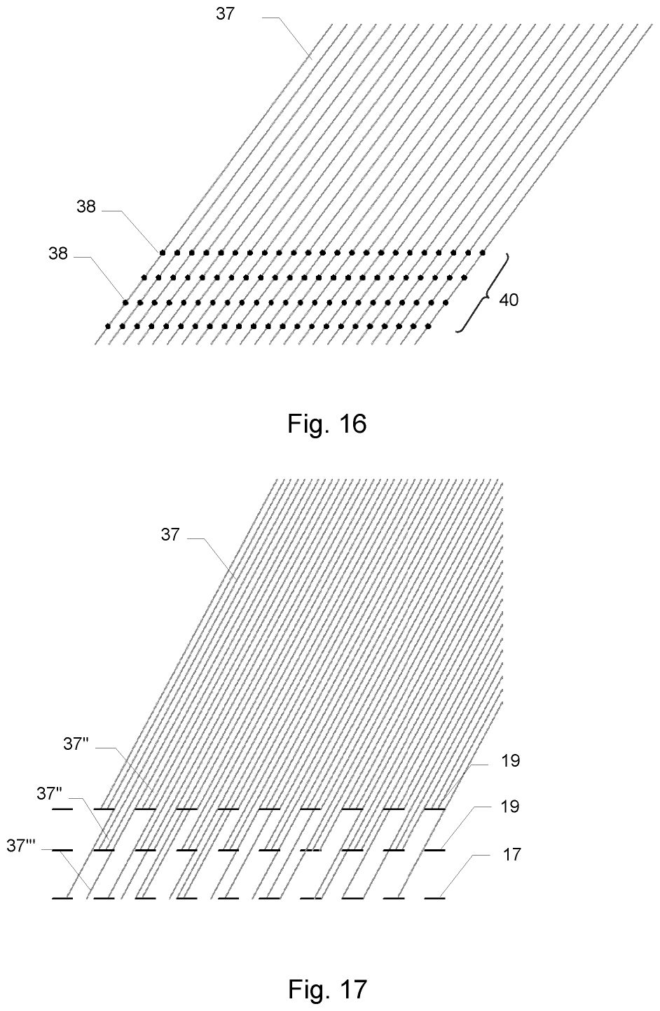

FIG. 15 shows three examples of the ply 13 with different fibre orientations. Here only the terminated edge 17 and the fibres 37 of the ply 13 are shown.

The fibres 37 are unidirectional fibres extending parallel (0 degrees) to the main fibre direction 39 as indicated in FIG. 5(a). The first cuts 38 are performed along multiple first cutting lines 19. The first cuts 38 along one first cutting line 19 may be aligned with or offset relative to the first cuts 38 of another first cutting line 19.

The fibres 37 are biaxial fibres extending in two different fibre directions relative to the main fibre direction 39 as indicated in FIG. 5(b). Here, the fibre directions are +45/−45 degrees relative to the main fibre direction 39, but other arrangements are also possible. The first cuts 38′ are arranged perpendicular to the different fibre orientations, thus one group of first cuts 38′ are arranged at an angle relative to another group of first cuts 38′.

The fibres 37 are triaxial fibres extending in three different fibre directions relative to the main fibre direction 39 as indicated in FIG. 5(b). Here, the fibre directions are +45/0/−45 degrees relative to the main fibre direction 39, but other arrangements are also possible. The first cuts 38′ are arranged perpendicular to the different fibre orientations, thus each group of first cuts 38′ are arranged at an angle relative to the other groups of first cuts 38′.

FIG. 16 shows a cutting pattern 39 for performed the first cutting of the ply 13. The individual local first cuts 38 arranged along the first cutting lines 19 together form the cutting pattern 40. The cutting tool 26 is adapted to perform the first cutting according to this cutting pattern 40.

FIG. 17 shows the ply 13 after the first cutting is complete. Here, the total number of shortened fibres 37″ increases from an innermost cutting line 19 towards the terminated edge 17.

1. A method of cutting plies (13) of a composite laminate of a wind turbine blade (5), the composite laminate comprising at least one ply (13) of a fibre-reinforced material having at least one terminated edge area (16) with at least one terminated edge (17), the at least one ply (13) extending in a longitudinal direction (14) and further in a width direction (15), and comprising fibres (37) extending in at least one fibre direction, wherein the method comprises:
performing a number of local first cuts (38) in the at least one terminated edge area (16) along at least one first cutting line (19) arranged relative to the at least one fibre direction, thereby shortening a percentage of the fibres (37) located along the at least one first cutting line (19) and thus forming a number of cut-off fibre ends (37″);
removing the cut-off fibre ends (37″) from the at least one terminated edge area (16).

2. The method according to claim 1, wherein the local first cuts (38) are performed along a plurality of first cutting lines (19) arranged relative to the at least one fibre direction, preferably the first cuts (38) of one cutting line (19) are offset relative to the first cuts (38) of another cutting line (19) in the at least one fibre direction.

3. The method according to claim 1, wherein the percentage of the fibres (37) being cut during the cutting is selected between 5% to 50% for each first cutting line (19).

4. The method according to claim 1, wherein the at least one ply (13) further comprises stitching yarns (31) extending in a yarn direction, wherein the method further comprises:
performing a number of local second cuts along at least one second cutting line (20) relative to the at least one terminated edge (17) in the at least one terminated edge area (16), thereby cutting the stitching yarns (31) located at the local second cuts to form a number of cut-off stitching yarn pieces (31″);
removing at least a portion of the cut-off stitching yarn pieces (31″) from the at least one terminated edge area (16).

5. The method according to claim 4, wherein the local second cuts are performed along a plurality of second cutting lines (20) arranged relative to the at least one terminated edge (17), preferably the second cutting lines (20) being parallel relative to each other.

6. The method according to claim 4, wherein the step of performing the local second cuts is performed either prior to or after the step of performing the local first cuts (38).

7. The method according to claim 4, wherein the first cuts (38) and the second cuts are performed simultaneously, and/or the removing of the cut-off fibre ends (37″) and the cut-off stitching yarn pieces (37″) are performed simultaneously.

8. The method according to claim 1, wherein at last the first cuts (38) are performed perpendicularly relative to an outer surface of the at least one ply (13) through a thickness (18) of the at least one ply (13).

9. The method according to claim 1, wherein the method further comprises:
mixing the shortened fibres (37′) with the uncut fibres (37′″) along the at least one terminated edge area (16) in random fibre directions.

10. The method according to claim 1, wherein the method comprises further removing one or more uncut stitching yarns (31′) from the at least one terminated edge area (16).

11. The method according to claim 1, wherein the removing of the cut-off fibre ends (37″), the cut-off stitching yarn pieces (31″) and, optionally, the uncut stitching yarns (31′) and/or the mixing of the shortened fibres (37′) and the uncut fibres (37″′) are performed by mechanical interaction with the least one ply (13) or by generating a forced air flow at the least one ply (13).

12. A composite laminate of a wind turbine blade (5), the composite laminate comprising at least one ply (13) formed by a fibre-reinforced material having at least one terminated edge area (16) with at least one terminated edge (17), the at least one ply (13) extending in a longitudinal direction (14) and further in a width direction (15), and the fibres (37) being arranged in at least one fibre direction, wherein the at least one ply (13) along the at least one terminated edge area (16) comprising fibres (37′) locally shortened at a number of local first cuts (38) extending along at least one first cutting line (19) and locally uncut fibres (37″′) extending along the terminated edge (17), wherein the locally shortened fibres (37′) are formed by shortening a percentage of the fibres (37) along the at least one first cutting line (19).

13. The composite laminate according to claim 12, wherein the fibres (37) are locally shortened along a plurality of first cutting lines (19) arranged relative to each other, each first cutting line (19) define a local length of the first cuts (38) located along that first cutting line (19).

14. The composite laminate according to claim 12, wherein the locally shortened fibres (37′) and the locally uncut fibres (37″′) are mixed along the at least terminated edge area (16) in random fibre directions; and/or the total number of shortened fibres (37′) at each first cutting line (19) increases towards the terminated edge (17).

15. The composite laminate according to claim 12, wherein at least a local width or a local length of the local first cuts (38) is uniform or varies along the at least one terminated edge area (16).

16. The composite laminate according to claim 12, wherein a local width(s) between adjacent local first cuts (38) are uniform or varies along the at least one terminated edge (17).

17. A cutting apparatus for cutting plies (13) of a composite laminate for a wind turbine blade (5), comprising:
a cutting base (34) with a top surface on which at least one ply (13) of a fibre-reinforced material can be positioned, the at least one ply (13) comprising fibres (37) extending in at least one fibre direction;
at least one cutting tool (26) arranged relative to the cutting base (34) and configured to perform a number of local first cuts (38) along at least one first cutting line (19) in the at least one ply (13), thereby shortening a percentage of the fibres (37′) located along the at least one first cutting line (19) and thus forming a number of cut-off fibre ends (37″);
optionally, at least one fixing unit (36) arranged relative to the base (34), wherein the at least one fixing unit (36) is configured to hold the at least one ply (13) in position relative to the at least cutting tool (26); and
means configured to remove at least the cut-off fibre ends (37″) from the at least one ply (13) after cutting.

18. The cutting apparatus according to claim 17, wherein the at least one cutting tool (26) comprises a plurality of first cutting elements (23, 23′, 23″) arranged in at least one first cutting direction, the first cutting elements (23, 23′, 23″) are configured to perform the local first cuts (38) perpendicularly through the at least one ply (13).

19. The cutting apparatus according to claim 18, wherein the at least one cutting tool (26) further comprises a plurality of second cutting elements (27, 27′) arranged in at least one second cutting direction, the second cutting elements (27, 27′) are configured to perform a number of local second cuts through the at least one ply (13).

20. The cutting apparatus according to claim 18, wherein at least the first cutting elements (23″) or the second cutting elements (27′) are arranged on at least one cutting die (22), preferably a rotary die or a plate shaped die, the at least one cutting die (22) is configured to be moved into contact with the at least one ply (13).

21. The cutting apparatus according to claim 18, wherein at least the first cutting element (23, 23′, 23″) each has a cutting edge (24, 24′, 24″) with an edge profile, the edge profile being selected to cut a predetermined percentage of the fibres (37) located along the at least one first cutting line (19) during the cutting.

22. The cutting apparatus according to claim 17, wherein the means configured to remove at least the cut-off fibre ends (37″) is a mechanical device configured to interact with the at least one ply (13) or an air system adapted to apply a suction or forced air onto the at least one ply (13).

23. The cutting apparatus according to claim 17, wherein the at least one fixing unit (36) comprises a mechanical fixing element or an air system adapted to apply a suction onto the at least one ply (13).

24. A wind turbine blade (5) of a wind turbine (1), wherein the wind turbine blade (5) comprises a composite laminate according to claim 12.
